(19) United States
(12) Patent Application Publication
(10) Pub. No.: US 2007/0112901 A1
(43) Pub. Date: May 17, 2007

(54) Configurable digital filter

(76) Inventors: Afshin Niktash, Irvine, CA (US); Alireza Moshtaghi, Irvine, CA (US); Behzad Barjesteh Mohebbi, San Diego, CA (US); Hooman Torabi Parizi, Aliso Viejo, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/274,038

(22) Filed: Nov. 15, 2005

(51) Int. Cl. G06F 17/10

(52) U.S. Cl. 708/300

(57) ABSTRACT

In one embodiment, a configurable device is provided for multiplying a plurality of digital words with a corresponding plurality of coefficients. The configurable digital filter includes: a plurality of lookup tables, each lookup table corresponding to at least one of the coefficients and operable to receive at least a portion of a corresponding at least one of the digital words, each lookup table configured multiples of the corresponding at least one coefficient such that the lookup table is operable to retrieve an entry to provide an output equaling a multiplication of the portion with the corresponding at least one coefficient.

### TECHNICAL FIELD

This invention relates generally to digital signal processing, and more particularly to a configurable device for performing multiply-and-accumulate operations.

### BACKGROUND

Designers of modern digital signal processing systems have typically used application-specific integrated circuits (ASICs) to implement their digital filter designs. A commonly-implemented digital filter design is what is denoted as a finite impulse response (FIR) digital filter. For example, the filtering requirements for various wireless telecommunication protocols such as WCDMA, GSM/EDGE, CDMA 2000, & TD-SCDMA may be implemented with such devices. Turning now to FIG. 1, a generic FIR filter 100 is illustrated. In the embodiment illustrated, FIR filter 100 is used to filter digital samples of an analog signal 110 as digitized by an analog-to-digital converter (ADC) 115. ADC 115 provides digitized sample of signal 110 responsive to cycles of a clock signal 120. A buffer 130 stores the resulting digitized samples from AD converter 115 so that they may be filtered by FIR filter 100.

The number of digitized samples filtered by FIR filter 100 depends upon the number of taps it possesses. Each tap is represented by a multiplier 140. FIR filter 100 includes an integer N number of taps and thus has N multipliers 140. Buffer 130 provides a corresponding number of N samples to the taps. The number of bits per sample at each tap may be denoted as the precision for FIR filter 100. For example, if each sample is one byte, the precision would be one byte. In FIR filter 100, a first multiplier 140a multiplies a current sample X₀ with a corresponding coefficient C₀. A second multiplier multiplies a sample X₁ (the sample preceding X₀) with a corresponding coefficient C₁, and so on. Finally, an Nth multiplier 140_{N} multiples a sample X_{N-1} with a corresponding coefficient C_{N-1}. A summer 150 sums the tap outputs (from the multipliers) to provide an output sample 160. It will thus be appreciated that FIR filter 100 provides a multiply-and-accumulate (MAC) function.

In an ASIC implementation of FIR filter 100, hardware is provided to implement multipliers 140 and summer 150. However, the filtering needs may vary widely depending upon the desired protocol. For example, a decimation filter for a WDCMA handset may have six taps, each tap having 10 bits of precision whereas a decimation filter for a TDMA handset may have 10 taps, each tap having 10 bits of precision. In general, the number of taps and bits of precision per tap will depend upon the application. An ASIC-implemented digital filter will typically have a fixed (rather than configurable) number of taps and bits of precision per tap. An ASIC designer having to support multiple digital filtering protocols is thus faced with the excessive die area demands of providing multiply-and-accumulate (MAC) hardware to meet worst-case scenarios (i.e., large number of taps with high bit precision) that may not be used.

As an alternative to an ASIC design, digital filters have been implemented using lookup tables (LUTs) such as provided in field programmable gate arrays and other configurable devices. Such LUT-based implementations use a distributed arithmetic approach to perform the necessary MAC operations. Although LUTs are readily reconfigurable, conventional LUT-based distributed arithmetic implementations of digital filters are awkward with regard to input/output (I/O) signal flow.

Accordingly, there is a need in the art for improved digital filter implementations having both a configurable number of taps and also a configurable number of bits of precision per tap.

### SUMMARY

In accordance with one aspect of the invention, a configurable device is provided for multiplying a plurality of digital words with a corresponding plurality of coefficients, comprising: a plurality of lookup tables, each lookup table corresponding to at least one of the coefficients and operable to receive at least a portion of a corresponding at least one of the digital samples, each lookup table configured with multiples of the corresponding at least one coefficient such that the lookup table is operable to retrieve an entry to provide an output equaling a multiplication of the portion with the corresponding at least one coefficient.

In accordance with another aspect of the invention, a method of implementing a first digital filter for multiplying a plurality of digital input words with a corresponding plurality of first coefficients is provided. The method includes the acts of: configuring at least one lookup table with multiples of each of the first coefficients; and for each digital input word, retrieving a selected one of the multiples of the first coefficients from the at least one lookup table to provide a tap output of the first digital filter, wherein each selected one of the multiples equals the digital input word multiplied by the corresponding coefficient.

In accordance with another aspect of the invention, a lookup table group operable to implement at least a tap for a digital filter is provided, wherein the tap corresponds to the multiplication of a digital input word with a coefficient. The lookup table group includes a plurality of lookup tables, each lookup table configured with multiples of the coefficient such that the lookup table is operable to retrieve an entry to provide an output equaling a multiplication of a portion of the digital input word with the coefficient.

### BRIEF DESCRIPTION OF THE DRAWINGS

FIG. 1 is a block diagram of a conventional FIR filter.

FIG. 2a illustrates the implementation of a tap for a 4-bit sample using a 4-bit LUT in accordance with an embodiment of the invention.

FIG. 2b is an illustration of a FIR filter implemented using LUTs in accordance with an embodiment of the invention.

FIG. 3 illustrates a LUT group in accordance with an embodiment of the invention.

FIG. 4 illustrates an exemplary configurable digital filter in accordance with an embodiment of the invention.

FIG. 5 illustrates an even-odd buffer in accordance with an embodiment of the invention.

FIG. 6 illustrates an adder network in accordance with an embodiment of the invention.

FIG. 7 illustrates multi-page lookup tables in accordance with an embodiment of the invention.

FIG. 8 illustrates a multi-page lookup table group in accordance with an embodiment of the invention.

Use of the same reference symbols in different figures indicates similar or identical items.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

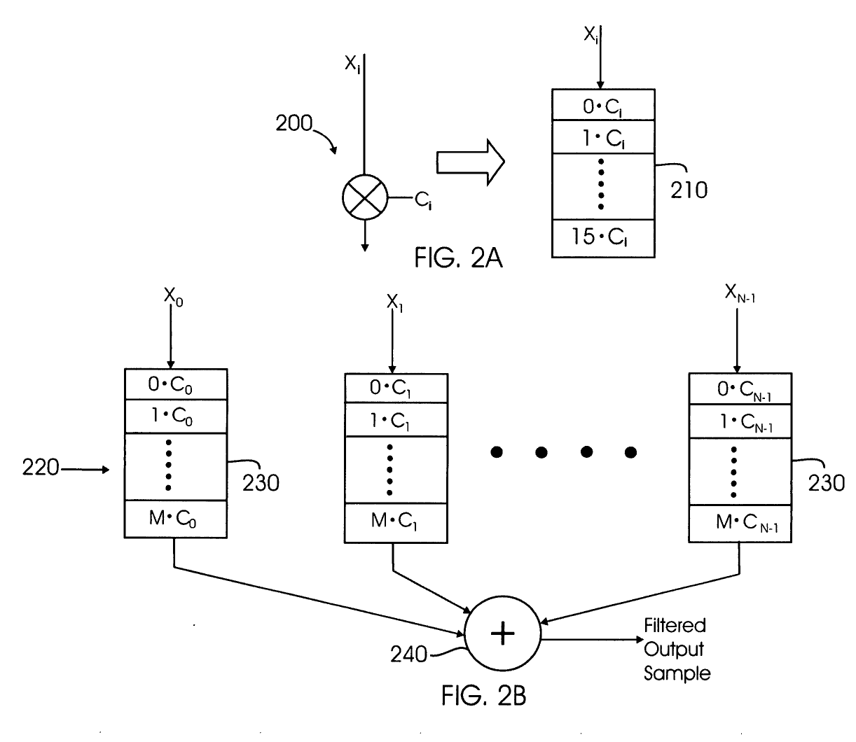

A lookup table (LUT)-based digital filter implementation is provided in which both the number of taps and the bits of precision used per tap are configurable. To provide an efficient implementation, a LUT is configured to implement one or more taps of a digital filter (the multiplication part of the desired MAC function). For example, if each sample has four bits of precision, there are thus sixteen potential values for each sample. In turn, there are thus sixteen potential values for each tap output. Turning now to FIG. 2a, with regard to an ith tap 200, its output comprises a value selected from the set of {0*Ci, 1*Ci, 2*Ci, . . . , 15*Ci} as determined by the value of a sample Xi. A LUT 210 may be programmed with these sixteen entries. Depending upon the actual value for the digitized sample Xi, the appropriate output is retrieved from LUT 210 to provide the tap output.

Turning now to FIG. 2b, a digital filter 220 may thus be implemented using an array of appropriately configured LUTs 230. Thus number of LUTs 230 depends upon the numbers of taps required to implement filter 220. In an embodiment in which each LUT corresponds uniquely to a tap for filter 220, the number of LUTs 230 thus equals the number of required taps. In general, each LUT 230 maps to at least one tap. The number of LUTs is represented by an integer N. The number of entries in each LUT is determined by the precision at each tap (the number of bits per sample). For generality, the number of entries in each LUT is represented by an integer m. A summer 240 sums the resulting outputs from LUTs to provide the current digitized output. Note the advantages provided by digital filter 220. To implement a desired FIR architecture, LUTs 230 need merely be loaded with the appropriate coefficient set. Moreover, the number of taps and bits of precision is entirely flexible and may be changed in the same fashion.

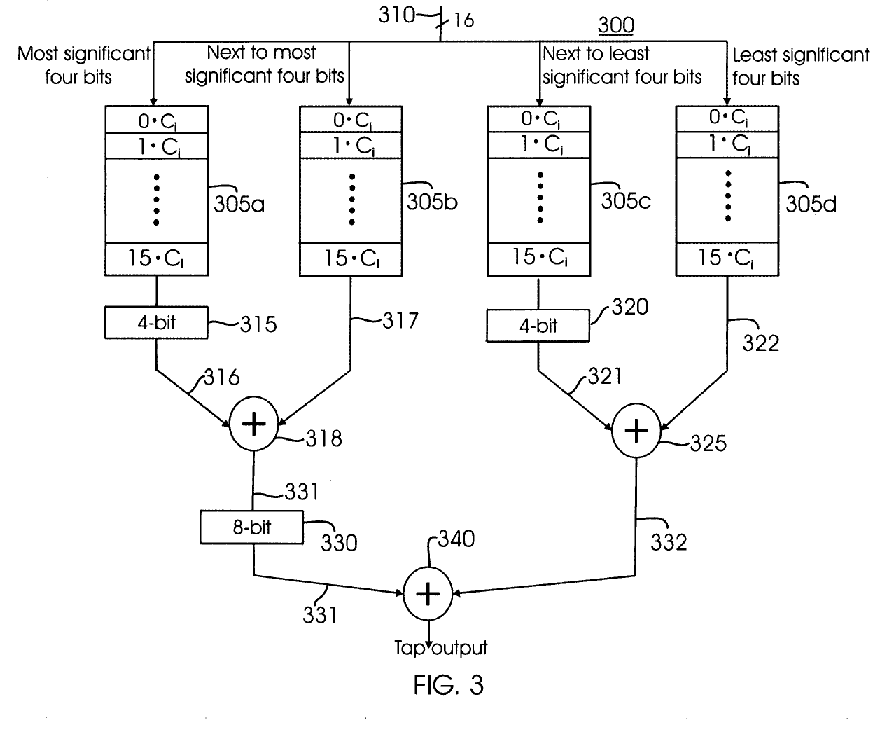

It will be appreciated that the required number of entries in each LUT (corresponding to integer m) will increase as the precision is increased. In that regard, communication protocols requiring, for example, 16 bits of precision at each tap are quite common. For example, handsets configured for either WCDMA or CDMA2000 require digital filters having 16 bits of precision at each tap. Each LUT would then require 64K entries to provide such a precision value. To avoid providing memory space for such relatively-large LUTs, each LUT may comprise a group of LUTs such that each group of LUTs implements a tap. For example, turning now to FIG. 3, a tap having sixteen bits of precision may be implemented using a LUT group 300 of four LUTs 305 of just sixteen entries each. Each LUT 305 would thus correspond to the multiplication of a tap coefficient Ci and four bits of the sample carried on a sixteen-bit bus 310. The most significant four bits on bus 310 couple to a LUT 305a, the next-to-most significant four bits couple to a LUT 305b, the least significant four bits couple to LUT 305d, and the next-to-least significant four bits couple to LUT 305c.

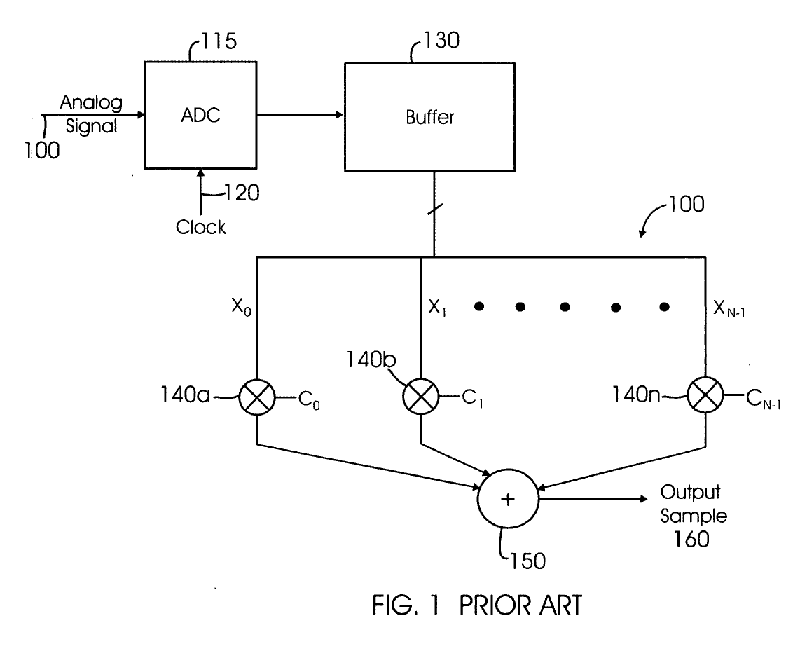

The coefficient value used to configure LUTs 305 in LUT group 300 will be represented by Ci to indicate that it represents an arbitrary coefficient tap value (such as C₀, C₁, etc from FIG. 1). Each LUT 305 may then be configured with the entries represented by the set of {0*Ci, 1*Ci, 2*Ci, . . . , 15*Ci} analogously as discussed with regard to FIG. 2a. However, outputs from LUT 305a through 305c will need to be shifted because LUTs 305 are loaded with the same entries. Thus, an output from LUT 305a is shifted by four bits in shift register 315 before a shifted output 316 sums with an output 317 from LUT 305b in summer 318. Similarly, a shift register 320 shifts an output from LUT 305c by four bits before a shifted output 321 sums with an output 322 from LUT 305d in an summer 325. In turn, a shift register 330 shifts an output from summer 318 by a byte before a shifted output 331 sums with an output 332 from summer 325 is a summer 340 to provide a tap output. In an alternative embodiment (not illustrated), the coefficient values loaded into LUTs 305a through 305c may be shifted in lieu of shifting LUT outputs. However, by shifting the LUT outputs as discussed with regard to LUT group 300, the same coefficient set may be loaded into each LUT. Operation of shift registers 315, 320, and 330 is optional in that LUT group 300 may be used to implement four four-bit precision taps rather than a single sixteen-bit precision tap.

As discussed with regard to FIG. 2b, each LUT in the LUT-based approach described performs the multiplication function for some or all of the bits of at least one tap. The number of taps assigned to any given LUT depends upon the LUT size versus the desired precision. For example, suppose a 2-bit precision digital filter is implemented using 4-bit LUTs. Thus, each LUT may be used for two taps. The coefficient for a first one of the taps may be denoted as C′ and the coefficient for a second one of the taps may be denoted as C″. The entries in the LUT would thus comprise the set of {0*C′+0*C″, 0*C′+1*C″, 0*C, +2*C″, 0*C′+3*C″, 1*C′+0*C″, 1*C′+1*C″, 1*C′+2*C″, 1*C′+3*C″, 2*C′+0*C″, 2*C′+1*C″, 2*C′+2*C″, 2*C′+3*C″, 3*C′+0*C″ 3*C′+1*C″, 3*C′+2*C″, 3*C′+3*C″}. Similarly, the same LUT may be configured to implement the multiplication for four taps of a 1-bit precision digital filter, and so on.

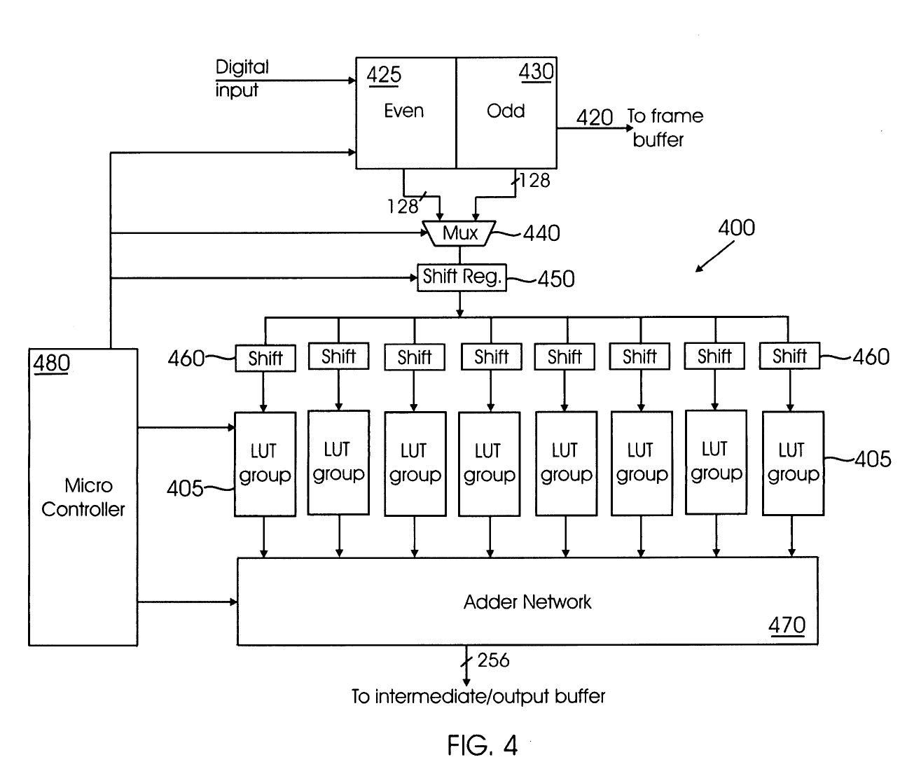

Configurable digital filters incorporating the LUT-based approach described herein may be implemented using an arbitrary number of LUTs. In addition, the bit size (number of entries) within each LUT is also arbitrary. The number of LUTs used and their size may thus be adjusted to suit individual design needs. Turning now to FIG. 4, a configurable device 400 is illustrated having eight LUT groups 405. A micro-processor 480 controls the components in configurable device 400 to implement desired multiply-and-accumulate (MAC) operations. For example, these MAC operations may correspond to those necessary to implement one or more digital filters. In that regard, configurable device 400 may be used as a configurable digital filter. However, it will be appreciated that device 400 may be used to implement other types of MAC operations besides those necessary in a digital filter implementation. Each LUT group 405 may be a group of four LUTs arranged as discussed with regard to FIG. 3 for LUTs 305. Thus, each LUT group 405 may be used to implement the multiplication function of a sixteen-bit tap. If the precision of a tap being implemented exceeds sixteen bits, multiple LUT groups 405 may be used to implement the tap. For example, a 32-bit tap may be implemented using two LUT groups 405. Alternatively, each LUT group may be used to implement four four-bit taps, and so on.

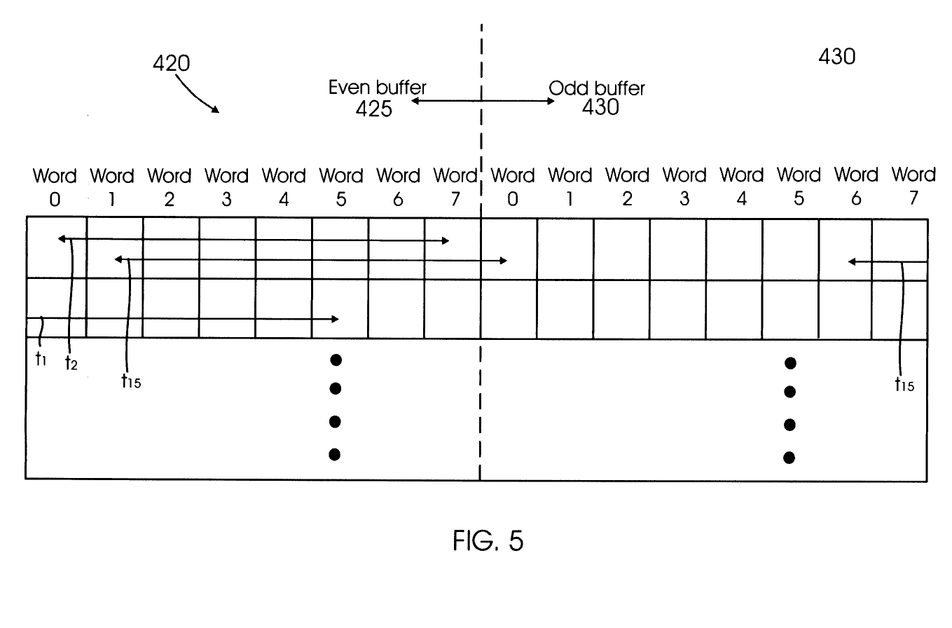

Because each LUT group 405 processes 16 bits of one or more taps at a time, eight LUT groups 405 processes 128 bits in parallel. A buffer 420 is thus required to provide these 128 bits. To aid in the retrieval of the appropriate bits, buffer 420 may be organized as a 256-bit wide memory, wherein each line of 256 bits is formed from two logical 128-bit wide memories: a even buffer 425, and an odd buffer 430. Operation of buffer 420 may be better understood with regard to the following example. Suppose a digital filter is being implemented having eight taps with 16-bit precision. Each line of even and odd buffers 425 and 430 each comprises eight input samples, which may be considered as being stored in a zeroth word location to an seventh word location as illustrated in FIG. 5. To provide any given output sample of such a filter thus requires eight input samples retrieved from these word locations. For example, to provide an output sample corresponding to a time t₁ may require the contents of the zeroth word location through the seventh word location of a first line in even buffer 425. However, the next output sample of the filter at a time t₂ would then require the contents of first through seventh word locations in the first line as well as the contents of the word 0 location in odd buffer 430. Similarly, to provide an output sample corresponding to a time t₁₅ would then require the contents of the sixth and seventh word locations in the first line of odd buffer 430 as well as the contents of the zeroth through fifth word locations in the second line of even buffer 425.

It will thus be appreciated that LUT groups 405 require samples selected from an “even-odd” line across buffer 420 or from an “odd-even” line across buffer 420. Referring back to FIG. 4, a multiplexer (MUX) 440 selects the appropriate 256-bit selection (even-odd or odd-even) from the even and odd buffers. For example, if the desired 128-bits needed to form an output sample corresponds to time t₂ in FIG. 5, the even-odd line selected by MUX 440 corresponds to the contents of the first line in buffer 420. Conversely, if the desired 128-bits corresponds to time t₁₅, the odd-even line selected by multiplexer corresponds to the contents of the first line in odd buffer 430 and the contents of the second line in even buffer 420. A shift register 450 then selects the appropriate 128-bits of samples from the 256-bit output selected by multiplexer 420. For example, if the 128-bits needed to form an output sample corresponds to time t₁, shift register 450 selects for the bits in word location 0 through word location 7 in the even portion of the even-odd line. Similarly, if the 128-bits needed to form an output sample corresponds to time t2, shift register 450 selects for the bits in word location 1 through word location 7 in the even portion and for the bits in word location 0 of the odd portion.

Multiple output samples may be produced in parallel by configurable device 400. For example, suppose a digital filter to be implemented has four taps of four-bit precision. Each LUT group 405 may thus implement instantiations of this filter. In that regard, a first LUT group 405 may process a first though a fourth input sample to provide an output sample. The subsequent output sample may be provided by an adjacent LUT group 405 by processing a second though a fifth input sample, and so on. It will thus be appreciated that each LUT group may be provided the appropriate input bits through selection by shifters 460. With regard to preceding example, a first shifter 460 would select the first through fourth input samples whereas a second shifter 460 would select the second through fifth input samples, and so on.

An adder network 470 processes the outputs from LUT groups 405 to provide an output word. In one embodiment, the output word may be a 256-bit wide output word. This output word is then provided to buffer 420. In that regard, buffer 420 comprises both an input buffer, an intermediate buffer, and an output buffer (all not illustrated). When operating as an input buffer, buffer 420 receives input samples from a source (not illustrated) such as an analog-to-digital converter. Should multiple filters be implemented simultaneously by configurable device 400, the output from adder network is written to the intermediate buffer, which then provides the input word to MUX 440 as discussed above. If all required digital filtering has been completed, the output from adder network 470 may be written to the output buffer. The contents of the output buffer may be provided to a frame buffer (not illustrated). A micro-controller 480 controls operation of configurable device 400. For example, micro-controller 480 controls the loading of the appropriate coefficient multiples into the LUTs within LUT groups 405. In addition, micro-controller controls the retrieval of input samples from buffer 420, and so on.

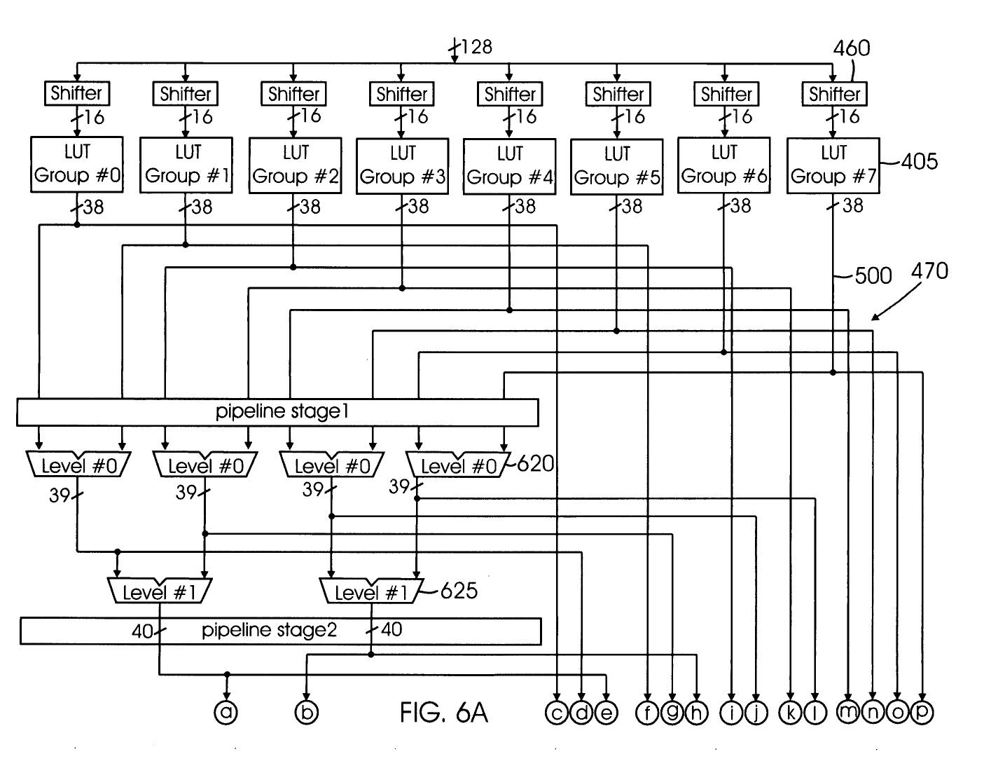

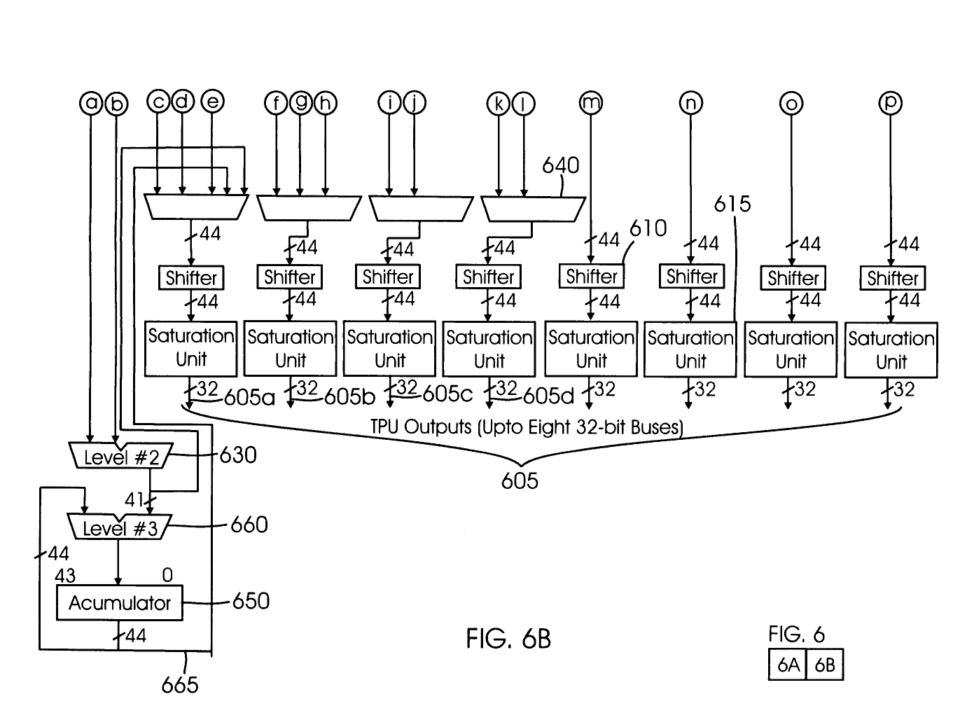

Operation of adder network 470 may be better understood with regard to FIG. 6. In one embodiment, each LUT group 405 may provide a 38-bit wide output word 600. In general, it will be appreciated that the width of output word 600 depends upon the maximum bit size of the coefficient multiples being loaded in the LUTs. For example, if the coefficients are 16-bit words and the LUTs are 4-bit LUTs, then the output words need only be 21-bit words (including a one-bit sign value). Should each LUT group correspond to a filter, then each LUT output 600 may be processed through adder network 470 to provide a corresponding adder network output 605. For example, each output 605 may be formed by processing the corresponding output word 600 through a shift register 610 and a saturation unit 615 such that outputs 605 are 32-bit wide words. On the other hand, should each LUT group correspond to just a single tap of an eight-tap filter, then output words 600 are summed through summers 620, summers 625, and a summer 630. The output from summer 630 then couples through a MUX 640 to eventually form output word 605a.

Conversely, should each LUT group 405 correspond to a tap of, for example, a 16 tap filter having 16 bits of precision, the first eight taps may be processed and stored in an accumulator 650. The next eight taps may then be processed and added to the previous taps values through feedback from accumulator 650 in a summer 660. An output 665 of accumulator 650 may then form output word 605a. It will be appreciated that filters having greater than 16 taps of 16-bit precision may be processed analogously through additional tap calculations and corresponding summations at accumulator 650. Adder network 470 has further configurability as well. In one embodiment, samples from a digital filter may be implemented in parallel through appropriate configuration of LUT groups 405 and adder network 470. For example, if each output sample is implemented using two LUT groups, there will be four output samples being provided in parallel. These outputs then correspond to output words 605a through 605d, which are formed from the outputs of summers 620. On the other hand, if each output sample is implemented using four LUT groups, there will be two output samples These outputs then correspond to corresponding output words 605a and 605b, which are formed using the outputs of summers 625.

Once LUT groups 405 have been loaded with the appropriate coefficient multiples to implement one or more digital filters, these groups must be re-loaded with new coefficient sets to implement different digital filters. Moreover, should the digital filter be large (such as with 16 taps of 16 bit coefficient), these groups would have to be reloaded just to implement a single digital filter. In such a case, a first cycle would process the first eight taps whereupon LUT groups 405 would require reconfiguration to process the ninth through sixteenth taps in a second cycle. Such reconfigurations require time and thus add overhead to the required processing time.

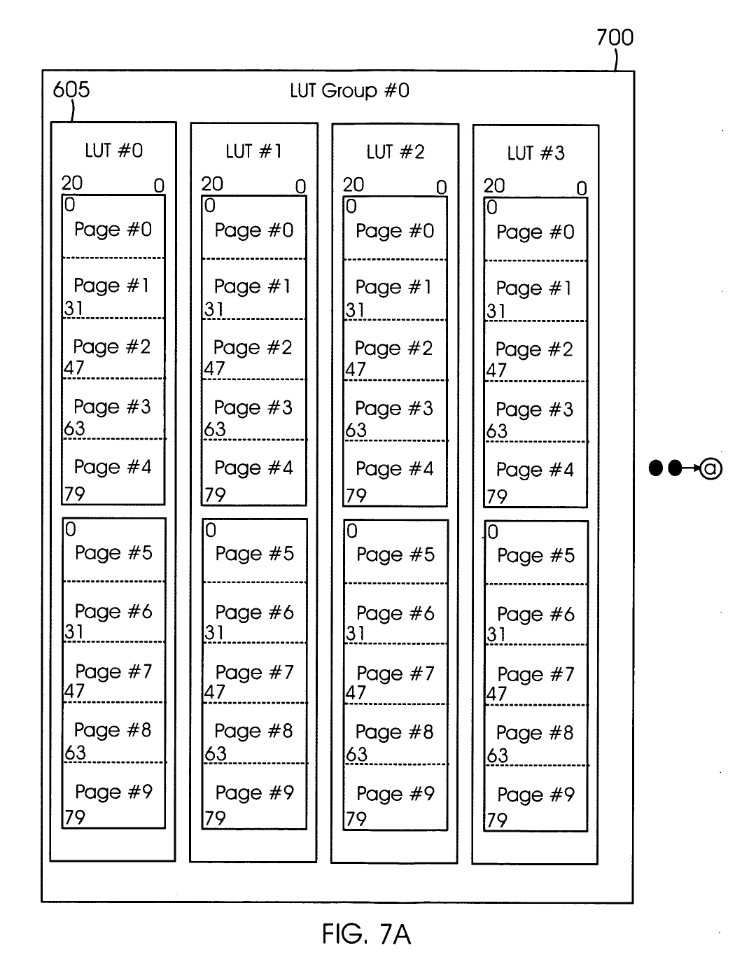

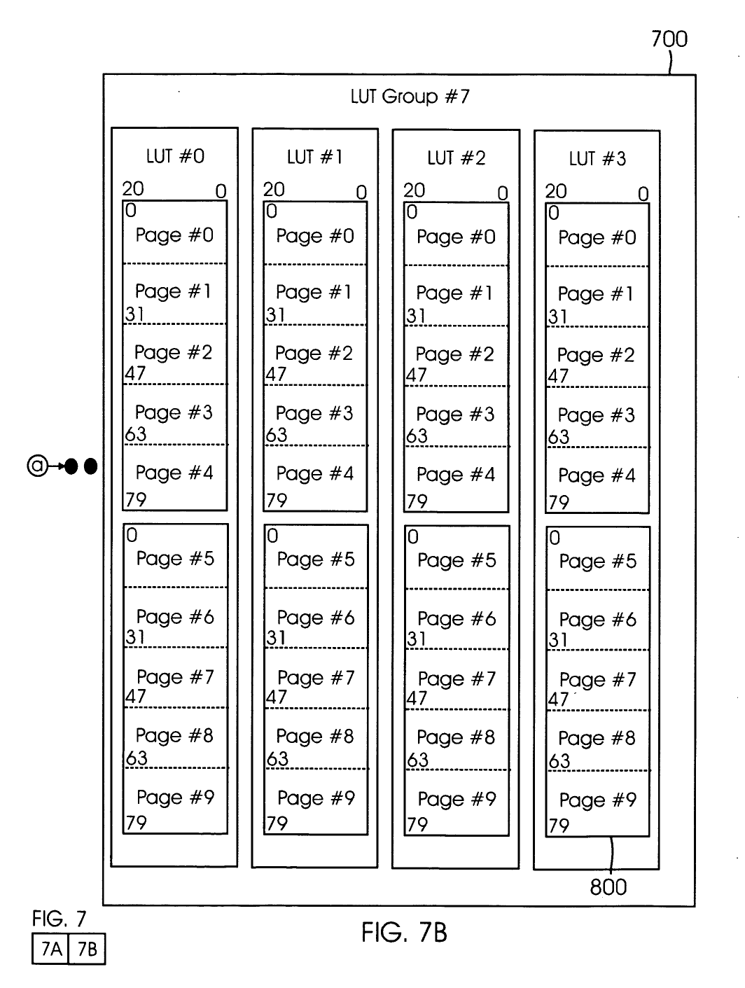

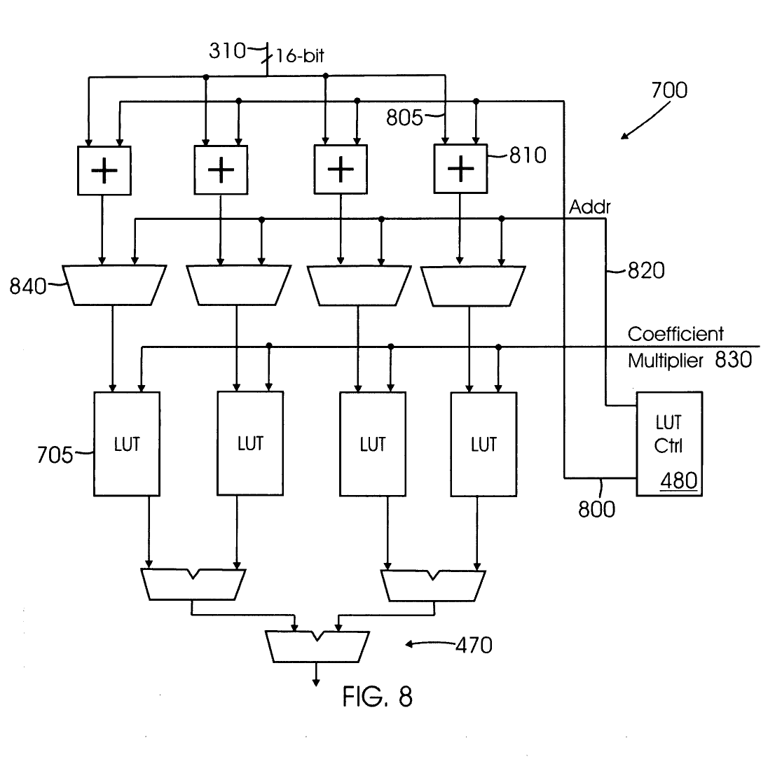

To avoid this overhead, multiple page lookup tables may be implemented such that switching between filters may be performed in a single calculation cycle. It will be understood that a “calculation cycle” refers to those calculations that may be performed without re-loading the LUTs with new coefficient multiples. Turning now to FIG. 7, LUT groups 700 are illustrated in a ten-page embodiment. Each page 705 may comprise a 4-bit LUT (not illustrated) as discussed with regard to FIG. 3. Operation of a LUT group 700 may be better understood with reference to FIG. 8. Input bus 310 carries an input word such as a sixteen-bit input word. Portions 805 of this input word are provided to LUTs 705 analogously as also discussed with regard to FIG. 3. However, a page address word 800 is also appended to portions 805 in summers under the control of micro-controller 480. Page address word 800 determines which page 705 (and hence LUT) receives portion 805. For example, suppose a 32-tap digital filter is being implemented with 16-bit precision. In a single page embodiment having eight LUT groups in which each LUT group includes four 4-bit LUTs, four calculation cycles would be required to provide an output sample. Between each cycle, the LUTs would have to be reloaded with the appropriate coefficient multiples, thereby introducing considerable latency and delay. However, in a multi-page embodiment, a first page 705 in each LUT group could be used to process the first eight taps, a second page 705 in each LUT group could be used to process another group of eight taps, and so on. In this fashion, an output sample could be provided in a single calculation cycle.

After a calculation cycle is finished, LUT pages 705 may be reloaded with new sets of coefficient multiples 830 to implement another digital filter is so desired. An address 820 provided by micro-controller 480 determines where a given coefficient multiple 830 will be written within LUT pages 705. During such configuration, multiplexers 840 select for addresses 820. However, during a calculation cycle, multiplexers 840 select for input portions 805.

The above-described embodiments of the present invention are merely meant to be illustrative and not limiting. For example, in addition to supporting a 4-bit LUT table mode, a configurable device such as device 400 of FIG. 4 could also include a 5-bit LUT mode. In a 5-bit mode, each LUT would include 32 entries. If there are 8 LUT groups having 4 LUTs each, a 5-bit mode would require a 256-bit input word rather than a 128 bit input word as discussed for a 4-bit mode. It will thus be obvious to those skilled in the art that various changes and modifications may be made without departing from this invention in its broader aspects. Accordingly, the appended claims encompass all such changes and modifications as fall within the true spirit and scope of this invention.

What is claimed is:

1. A device for multiplying a plurality of digital words with a corresponding plurality of coefficients, comprising:
a plurality of lookup tables, each lookup table corresponding to at least one of the coefficients and operable to receive at least a portion of a corresponding at least one of the digital words, each lookup table configured with multiples of the corresponding at least one coefficient such that the lookup table is operable to retrieve an entry to provide an output equaling a multiplication of the portion with the corresponding at least one coefficient.

2. The device of claim 1, further comprising:
a buffer operable to provide the plurality of digital words to the lookup tables.

3. The device of claim 1, further comprising:
at least one summer operable to sum the outputs from the plurality of lookup tables.

4. The device of claim 1, further comprising:
a controller operable to configure the lookup tables with the multiples of the corresponding at least one coefficient.

5. The device of claim 1, further comprising a controller operable to load the at least one lookup table with the multiples of the coefficients.

6. A method of implementing a first digital filter for multiplying a plurality of digital input words with a corresponding plurality of first coefficients, comprising:
configuring at least one lookup table with multiples of each of the first coefficients; and
for each digital input word, retrieving a selected one of the multiples of the first coefficients from the at least one lookup table to provide a tap output of the first digital filter, wherein each selected one of the multiples equals the digital input word multiplied by the corresponding coefficient.

7. The method of claim 6, further comprising summing the tap outputs to provide an output sample of the first digital filter.

8. The method of claim 6, further comprising implementing a second digital filter for multiplying the output samples with a corresponding plurality of second coefficients, comprising:
configuring at least another one lookup table with multiples of each of the second coefficients; and
for each output sample of the first digital filter, retrieving a selected one of the multiples of the second coefficients from the at least another one lookup table to provide a tap output of the second digital filter, wherein each selected one of the multiples equals the output sample multiplied by the corresponding coefficient.

9. The method of claim 8, further comprising summing the tap outputs of the second digital filter to provide an output sample of the second digital filter.

10. The method of claim 6, further comprising: receiving an analog signal; and
digitizing the analog signal to provide the digital input words.

11. A lookup table group operable to implement at least a tap for a digital filter, wherein the tap corresponds to the multiplication of a digital input word with a coefficient, comprising:
a plurality of lookup tables, each lookup table configured with multiples of the coefficient such that the lookup table is operable to retrieve an entry to provide an output equaling a multiplication of a portion of the digital input word with the coefficient.

12. The lookup table group of claim 11, wherein each lookup table is a four-bit lookup table.

13. The lookup table group of claim 11, wherein each lookup table is a five-bit lookup table.

14. The lookup table group of claim 11, wherein each digital input word is a sixteen-bit digital input word.

15. The lookup table group of claim 11, further comprising an adder network for adding the outputs of the lookup tables to form a tap output.
